(19) United States
(12) Patent Application Publication
(10) Pub. No.: US 2020/0233723 A1
(43) Pub. Date: Jul. 23, 2020

(54) CONSOLIDATION OF IDENTICAL VIRTUAL MACHINES ON HOST COMPUTING SYSTEMS TO ENABLE PAGE SHARING

(71) Applicant: VMWARE, INC., Palo Alto, CA (US)

(72) Inventors: CHANDRASHEKHAR JHA, Bangalore (IN); SHIVANJU AWASTHI, Bangalore (IN); AKASH SRIVASTAVA, Bangalore (IN); NAVEEN MUDNAL, Bangalore (IN); RITESH JHA, Bangalore (IN)

(21) Appl. No.: 16/365,880

(22) Filed: Mar. 27, 2019

(30) Foreign Application Priority Data
Jan. 17, 2019 (IN) 201941002031

(51) Int. Cl. G06F 9/50; G06F 16/906; G06F 9/455

(52) U.S. Cl. CPC G06F 9/5077; G06F 16/906; G06F 2009/45583; G06F 2009/45595; G06F 2009/4557; G06F 9/45558

(57) ABSTRACT

In one example, configuration data and resource utilization data associated with a plurality of virtual machines in a data center may be retrieved. Further, a cluster analysis may be performed on the configuration data and the resource utilization data to generate a plurality of clusters. Each cluster may include identical virtual machines from the plurality of virtual machines. Furthermore, for each cluster, the identical virtual machines in a cluster may be consolidated to execute in a host computing system such that physical memory pages are shared by the consolidated identical virtual machines in the cluster.

### RELATED APPLICATIONS

Benefit is claimed under 35 U.S.C. 119(a)-(d) to Foreign Application Serial No. 201941002031 filed in India entitled “CONSOLIDATION OF IDENTICAL VIRTUAL MACHINES ON HOST COMPUTING SYSTEMS TO ENABLE PAGE SHARING”, on Jan. 17, 2019, by VMware, Inc., which is herein incorporated in its entirety by reference for all purposes.

### TECHNICAL FIELD

The present disclosure relates to computing environments, and more particularly to methods, techniques, and systems for consolidating identical virtual machines on host computing systems to enable page sharing.

### BACKGROUND

Computer virtualization may be a technique that involves encapsulating a representation of a physical computing machine platform into a virtual machine (VM) that may be executed under the control of virtualization software running on hardware computing platforms. The hardware computing platforms may also be referred as host computing systems or servers. In such a computing environment, multiple host computing systems may execute different types of virtual machines running therein. An example host computing system may be a physical computer system. A virtual machine can be a software-based abstraction of the physical computer system. Each virtual machine may be configured to execute an operating system (OS), referred to as a guest OS, and applications. Further, two or more virtual machines running on a host computing system may share memory associated with the host computing system to execute applications.

### BRIEF DESCRIPTION OF THE DRAWINGS

FIG. 1 is a block diagram of an example data center, including a virtual machine migration unit for consolidating identical virtual machines on host computing systems based on a cluster analysis to enable page sharing;

FIG. 2A is a block diagram of an example data center, including the virtual machine migration unit of FIG. 1 to generate a virtual machine migration plan for consolidating identical virtual machines in the data center;

FIG. 2B is a block diagram of example data center of FIG. 2A, including the virtual machine migration unit to migrate the identical virtual machines in accordance with the virtual machine migration plan of FIG. 2A;

FIG. 3 is an example schematic diagram depicting consolidation of identical virtual machines in a data center;

FIG. 4 is a graphical representation of identical virtual machines that are identified using a cluster analysis;

FIG. 5 is an example flow diagram illustrating consolidation of identical virtual machines on host computing systems to enable page sharing; and

FIG. 6 is a block diagram of an example computing device including non-transitory computer-readable storage medium storing instructions to consolidate identical virtual machines on host computing systems to enable page sharing.

The drawings described herein are for illustration purposes only and are not intended to limit the scope of the present subject matter in any way.

### DETAILED DESCRIPTION

Examples described herein may provide an enhanced computer-based and network-based method, technique, and system for consolidating identical virtual machines on host computing systems to enable page sharing in a data center. The data center may be a virtual data center (e.g., a cloud computing environment, a virtualized environment, and the like). The virtual data center may be a pool or collection of cloud infrastructure resources designed for enterprise needs. The resources may be a processor (e.g., central processing unit (CPU)), memory (e.g., random-access memory (RAM)), storage (e.g., disk space), and networking (e.g., bandwidth). Further, the virtual data center may be a virtual representation of a physical data center, complete with servers, storage clusters, and networking components, all of which may reside in virtual space being hosted by one or more physical data centers.

Further, the data center may include multiple host computing systems executing corresponding virtual machines. Example host computing system may be a physical computer. The virtual machines, in some examples, may operate with their own guest operating systems on a host computing system using resources of the host computing system virtualized by virtualization software (e.g., a hypervisor, virtual machine monitor, and the like). In one example, the host computing systems may include hardware memory (e.g., also referred as physical memory or host physical memory). Further, the virtual machines running on the corresponding host computing systems may share the hardware memory for their operations.

In some examples, the virtualization software may enable sharing memory pages of the hardware memory across virtual machines. For example, multiple virtual machines, running instances of the same guest operating system, may have the same applications or components loaded, and/or contain common data. In such cases, a memory page sharing technique may be used to securely eliminate redundant copies of memory pages in the hardware memory. However, the virtual machines may be deployed on different host computing systems by different personas from different organizations, which may lead to suboptimal distribution of virtual machines (e.g., having different types of applications or operating systems) across multiple host computing systems in the data center. In this case, the memory page sharing mechanism may become ineffective.

Examples described herein may intelligently identify virtual machines with similar or identical configuration and provide a recommendation to optimally distribute the identical virtual machines across multiple host computing systems in a data center. Examples described herein may significantly maximize memory page sharing and create an opportunity to deploy additional virtual machines on a same infrastructure without any impact on applications' performance. For example, consider there are 30 virtual machines having 6 types of different configurations in a data center. Also, consider each type of configuration may have 5 identical virtual machines. Examples described herein may determine the identical virtual machines and place the identical virtual machines on corresponding ones of host computing systems in the data center. In this example, each group of 5 identical virtual machines may be placed on a corresponding host computing system to enhance memory page sharing.

System Overview and Examples of Operation

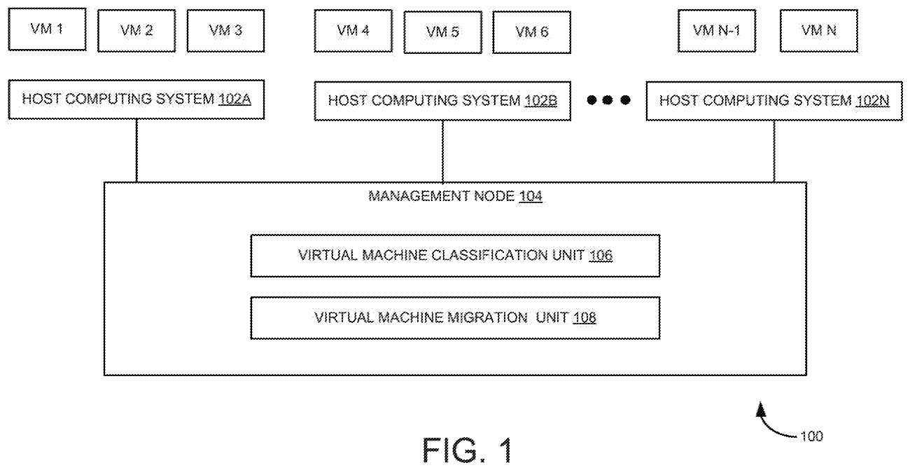

FIG. 1 is a block diagram of an example data center 100, including a virtual machine migration unit 108 for consolidating identical virtual machines on host computing systems 102A-102N based on a cluster analysis to enable page sharing. Example data center 100 may be a virtual data center. As shown in FIG. 1, data center 100 may include multiple host computing systems 102A-102N, each executing corresponding ones of virtual machines VM 1 to VM N. Example host computing system (e.g., 102A-102N) may be a physical computer. The physical computer may be a hardware-based device (e.g., a personal computer, a laptop, or the like) including an operating system (OS). A virtual machine (e.g., VM 1 to VM N) may operate with its own guest OS on the physical computer using resources of the physical computer virtualized by virtualization software (e.g., a hypervisor, a virtual machine monitor, and the like).

For example, clusters of host computing systems 102A-102N may be used to support clients for executing various applications. Each cluster can include any number of host computing systems ranging from one to several hundred or more. Each client may be associated with a resource reservation to support application operations. Example client may be a customer, business group, tenant, an enterprise, and the like. In cloud computing environments, a number of virtual machines can be created for each client and resources (e.g., CPU, memory, storage, and the like) may be allocated for each virtual machine to support application operations.

As shown in FIG. 1, data center 100 may include a management node 104 communicatively coupled to host computing systems 102A-102N via a network. Example network can be a managed Internet protocol (IP) network administered by a service provider. For example, the network may be implemented using wireless protocols and technologies, such as WiFi, WiMax, and the like. In other examples, the network can also be a packet-switched network such as a local area network, wide area network, metropolitan area network, Internet network, or other similar type of network environment. In yet other examples, the network may be a fixed wireless network, a wireless local area network (LAN), a wireless wide area network (WAN), a personal area network (PAN), a virtual private network (VPN), intranet or other suitable network system and includes equipment for receiving and transmitting signals.

Further, management node 104 may include a virtual machine classification unit 106 to retrieve configuration data and resource utilization data associated with virtual machines VM 1 to VM N in data center 100. In one example, the configuration data may include at least one parameter such as virtual machine inventory information (e.g., virtual machine identifier), a guest operating system type and version, memory information, central processing unit (CPU) information, disk drive information, network adapter information, a type and version of an application, host computing system information, host cluster information, configuration settings associated with each of virtual machines VM 1 to VM N, and/or the like. The resource utilization data may include performance metric parameters such as processor utilization data, memory utilization data, network utilization data, storage utilization data, and/or the like.

Furthermore, virtual machine classification unit 106 may perform a cluster analysis on the configuration data and the resource utilization data to generate clusters. In one example, each cluster may include identical virtual machines from virtual machines VM 1 to VM N. Example cluster analysis may include a Gaussian-means (G-means) cluster, a support vector cluster, or the like. In one example, virtual machine classification unit 106 may encode categorial variables associated with the configuration data and the resource utilization data. Further, virtual machine classification unit 106 may perform the cluster analysis on the encoded categorial variables to generate the clusters. For example, each cluster may include identical virtual machines with similar configurations based on at least one parameter selected from the configuration data and the resource utilization data.

As shown in FIG. 1, management node 104 may include virtual machine migration unit 108 to consolidate (i.e., for each cluster) the identical virtual machines in a cluster to execute in a host computing system such that physical memory pages are shared by the consolidated identical virtual machines in the cluster. In one example, the physical memory pages including identical content may be shared by the identical virtual machines using a page sharing mechanism.

In one example, virtual machine migration unit 108 may generate a virtual machine migration plan for the identical virtual machines in the clusters based on resources availability associated with host computing systems 102A-102N. Example resources availability may include a processing resource availability, a memory resource availability, a network resource availability, a storage resource availability, or any combination thereof. Further, virtual machine migration unit 108 may recommend (e.g., to a data center administration) the virtual machine migration plan to consolidate the identical virtual machines in each cluster to execute in a corresponding one of host computing systems 102A-102N. Furthermore, based on an instruction from the data center administrator, virtual machine migration unit 108 may migrate the identical virtual machines to consolidate the identical virtual machines in each cluster to execute in the corresponding one of host computing systems 102A-102N in accordance with the recommended virtual machine migration plan.

In another example, virtual machine migration unit 108 may sequentially place the clusters of identical virtual machines on host computing systems 102A-102N during hardware upgrade in data center 100. For example, virtual machine migration unit 108 may place the identical virtual machines in a first cluster of the clusters on a first host computing system (e.g., 102A) during the hardware upgrade in data center 100 such that the physical memory pages are shared by the placed identical virtual machines within first host computing system 102A. Further, virtual machine migration unit 108 may repeat the step of placing the identical virtual machines in a next cluster until the identical virtual machines in all the clusters are placed on corresponding ones of host computing systems (e.g., 102B-102N) in data center 100.

In some examples, the functionalities described herein, in relation to instructions to implement functions of virtual machine classification unit 106, virtual machine migration unit 108, and any additional instructions described herein in relation to the storage medium, may be implemented as engines or modules comprising any combination of hardware and programming to implement the functionalities of the modules or engines described herein. The functions of virtual machine classification unit 106 and virtual machine migration unit 108 may also be implemented by a respective processor. In examples described herein, the processor may include, for example, one processor or multiple processors included in a single device or distributed across multiple devices. In some examples, virtual machine classification unit 106 and virtual machine migration unit 108 can be a part of management software (e.g., vSphere virtual center that is offered by VMware®) residing in management node 104.

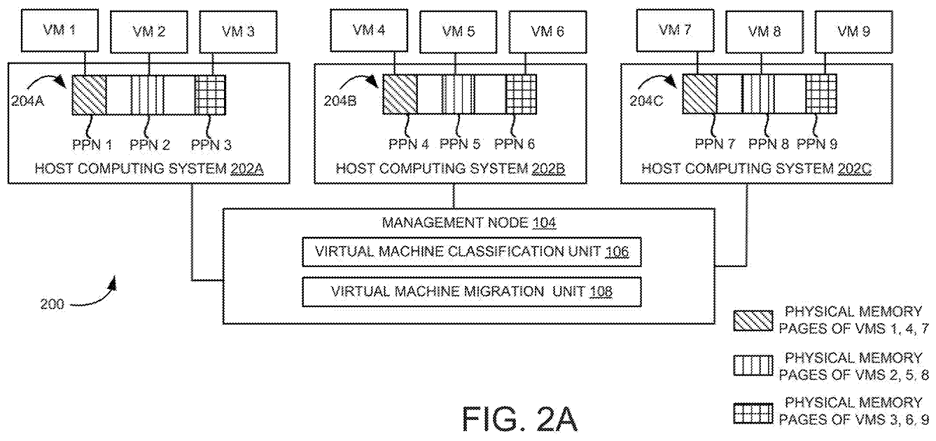

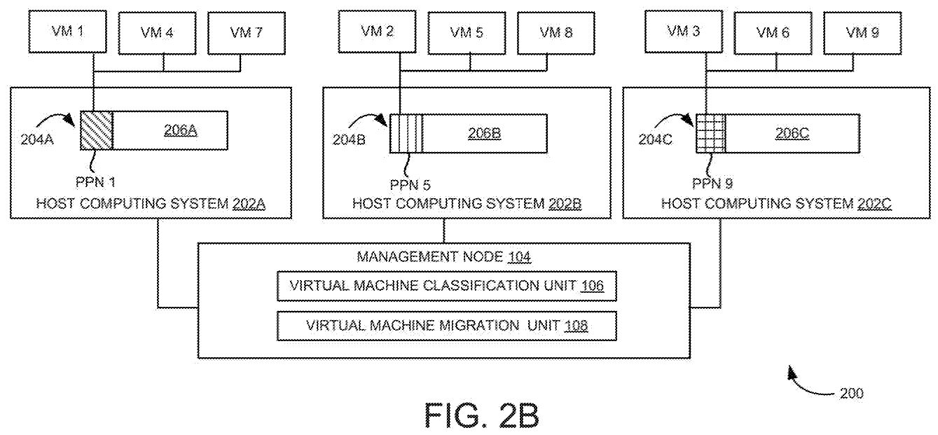

FIG. 2A is a block diagram of an example data center 200, including virtual machine migration unit 108 of FIG. 1 to generate a virtual machine migration plan for consolidating identical virtual machines in data center 200. Similarly named elements of FIG. 2A may be similar in function and/or structure to elements described in FIG. 1. Example data center 200 may include three host computing systems 202A-202C, each executing corresponding ones of virtual machines VM 1 to VM 9. For example, virtual machines VM 1 to VM 3 are running on a host computing system 202A, virtual machines VM 4 to VM 6 are running on a host computing system 202B, and virtual machines VM 7 to VM 9 are running on a host computing system 202C.

As shown in FIG. 2A, host computing systems 202A-202C may include hardware memory 204A-204C, respectively. In one example, hardware memory 204A-202C may include physical memory pages referred by physical page numbers, however, it can be noted that any other memory units such as blocks, regions, or other analogous allocation units can also be used.

In the example shown in FIG. 2A, the address space of physical memory 204A includes physical memory pages PPN 1, PPN 2, and PPN 3, the address space of physical memory 204B includes physical memory pages PPN 4, PPN 5, and PPN 6, and the address space of physical memory 204C includes physical memory pages PPN 7, PPN 8, and PPN 9. Further, host computing system 202A executes VM 1, VM 2, and VM3 that are mapped to PPN 1, PPN 2, and PPN 3, respectively, of hardware memory 204A. Host computing system 202B executes VM 4, VM 5, and VM 6 that are mapped to PPN 4, PPN 5, and PPN 6, respectively, of hardware memory 204B. Host computing system 202C executes VM 7, VM 8, and VM 9 that are mapped to PPN 7, PPN 8, and PPN 9, respectively, of hardware memory 204C. The drawings described herein are for illustration purposes only and are not intended to limit the scope of the present subject matter in any way.

Further, consider virtual machines VM 1 to VM 9 may be deployed with different operating systems such as SuSE® Linux™, Windows®, Ubuntu® Linux™, and the like operating systems. Furthermore, consider VM 1, VM 4, and VM 7 are deployed with SuSE® Linux™ operating system. VM 2, VM 5, and VM 8 are deployed with Windows® operating system. VM 3, VM6, and VM 9 are deployed with Ubuntu® Linux™ operating system. In this example, heterogeneous types of operating systems and applications are running on virtual machines VM 1 to VM 3 of same host computing system 202A. Thus, there may not be any common files between virtual machines VM 1 to VM 3 and hence, none of the physical memory pages PPN 1, PPN 2, and PPN 3 of hardware memory 204A may be shared between virtual machines VM 1 to VM 3.

As shown in FIG. 2A, data center 200 may include management node 104 communicatively coupled to host computing systems 202A-202C. Management node 104 may include a virtual machine classification unit 106 and virtual machine migration unit 108. In one example, virtual machine classification unit 106 may retrieve configuration data and resource utilization data associated with virtual machines VM 1 to VM 9. Further, virtual machine classification unit 106 may perform a cluster analysis on the configuration data and the resource utilization data to generate clusters. Each cluster may include the identical virtual machines from virtual machines VM 1 to VM 9. In this example, virtual machines VM 1, VM 4, and VM 7 may belong to a first cluster as virtual machines VM 1, VM 4, and VM 7 are deployed with same operating system (e.g., SuSE® Linux™ operating system). Virtual machines VM 2, VM 5, and VM 8 may belong to a second cluster as virtual machines VM 2, VM 5, and VM 8 are deployed with same operating system (e.g., Windows® operating system). Further, virtual machines VM 3, VM 6, and VM 9 may belong to a third cluster as virtual machines VM 3, VM 6, and VM 9 are deployed with same operating system (e.g., Ubuntu® Linux™ operating system). For example, virtual machine VM 1 may use a physical memory page PPN 1 having identical content as physical memory pages PPN 4 and PPN 7 used by virtual machines VM 4 and VM 7 as shown in FIG. 2A.

In one example, virtual machine migration unit 108 may consolidate the identical virtual machines in each cluster by generating the virtual machine migration plan based on resources availability associated with host computing systems 202A-202C. For example, in the virtual machine migration plan, the identical virtual machines VM 1, VM 4, and VM 7 in the first cluster may be consolidated to execute on a same host computing system such that physical memory pages are shared by the consolidated identical virtual machines VM 1, VM 4, and VM 7. The migration of the identical virtual machines in accordance with the virtual machine migration plan is described in FIG. 2B.

FIG. 2B is a block diagram of example data center 200 of FIG. 2A, including virtual machine migration unit 108 to migrate the identical virtual machines in accordance with the virtual machine migration plan of FIG. 2A. In one example, virtual machine migration unit 108 may migrate the identical virtual machines to consolidate the identical virtual machines in each cluster to execute in the corresponding one of host computing systems 202A-202C in accordance with the virtual machine migration plan. In the example shown in FIG. 2B, virtual machines VM 4 and VM 7 in the first cluster may be migrated to execute on host computing system 202A such that physical memory page PPN 1 can be shared by the identical virtual machines VM 1, VM 4, and VM 7. Similarly, virtual machines VM 2 and VM 8 in the second cluster may be migrated to execute on host computing system 202B such that physical memory page PPN 5 can be shared by the identical virtual machines VM 2, VM 5, and VM 8. Further, virtual machines VM 3 and VM 6 in the third cluster may be migrated to execute on host computing system 202C such that physical memory page PPN 9 can be shared by the identical virtual machines VM 3, VM 6, and VM 9.

In one example, physical memory pages associated with hardware memory 204A-204C may be shared by the identical virtual machines as shown in FIG. 2B. Therefore, the memory consumption of the virtual machines VM1 to VM9 can be reduced and hence additional virtual machines can be deployed on host computing systems 202A-202C using created available memory 206A-206C in respective host computing systems 202A-202C. Thus, examples described herein may maximize the page sharing without impacting the system performance by determining the identical virtual machines and placing them on same host computing systems 202A-202C. In other words, amount of memory used by the virtual machines VM 1 to VM 9 may be significantly minimized by storing a single copy of the memory page with identical content in the hardware memory 204A-204C, i.e., rather than storing an individual copy of the memory page for each virtual machine.

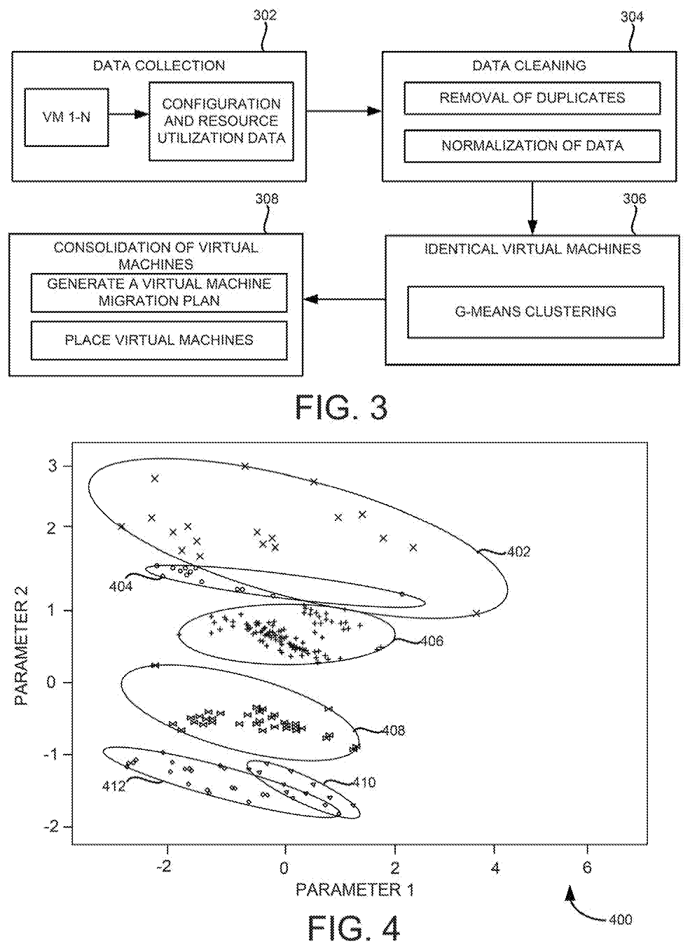

FIG. 3 is an example schematic diagram depicting consolidation of identical virtual machines in a data center. At 302, configuration data and resource utilization data associated with virtual machines VM 1 to VM N in the data center may be retrieved. At 304, the configuration data and the resource utilization data may be cleaned for missing values, outliers, duplicate entries, and the like. In this example, the duplicate entries may be removed from the configuration data and the resource utilization data and/or the configuration data and the resource utilization data may be normalized. An example configuration data and resource utilization data associated with the virtual machines may be depicted in Table 1.

TABLE 1

| VM | Memory | CPU | Storage | Software | | | Host |
|---|---|---|---|---|---|---|---|
| ID | GB | count | GB | Name | App | Host | Cluster |
| 367 | 4 | 4 | 100 | Ubuntu | vRBC | Chan | MyDev |
| 125 | 4 | 2 | 40 | Windows | Tomcat | Aka | Lab |
| 246 | 4 | 2 | 40 | Windows | RDC | Chan | MyDev |
| 222 | 2 | 1 | 32 | CoreOS | Oracle | Aka | Lab |
| | | | | | DB | | |
| 488 | 8 | 4 | 80 | SUSE | Tomcat | Shiv | Dev |
| 246 | 4 | 2 | 40 | Ubuntu | vRBC | Shiv | Dev |

At 306, a cluster analysis may be performed on the configuration data and the resource utilization data of Table 1 to generate clusters. Each cluster may include identical virtual machines from virtual machines VM 1 to VM N. In one example, categorial variables associated with parameters of the configuration data and the resource utilization data may be encoded and the cluster analysis may be performed on the encoded categorial variables to generate the clusters. For example, the categorical variables such as software name, applications, and the like may be encoded in discrete integer values. In the example, each of the 4 types of software names (e.g., Ubuntu, Windows, CoreOS, and SuSe) may be assigned with one integer value. Further, different parameters may be selectively considered. For example, parameters such as host and host cluster may be used when cluster affinity may be required.

In one example, the cluster analysis may include one of a Gaussian-means (G-means) cluster, a support vector cluster, and the like. G-means clustering algorithm may be an extension of k-means clustering algorithm to determine an appropriate number of clusters (e.g., k). The G-means algorithm may begin with a small number of k-means centers and increases the number of centers. Each iteration of the algorithm may split into two those centers whose data appear not to come from a Gaussian distribution. Further, between each round of splitting, k-means cluster may be applied on the entire dataset. In one example, the value of k may be initialized as 1 or other value may be specified for k if an administrator is aware about the range of k.

Further, G-means repeatedly makes decisions based on a statistical test for the configuration data and the resources utilization data assigned to each center. If the data currently assigned to a k-means center appear to be Gaussian, then the data may be represented with only one center. However, if the same data do not appear to be Gaussian, then multiple centers may be used to model the data. In other words, the G-means algorithm may run k-means multiple times. For example, consider a data set ‘X’ with ‘d’ dimensions belong to center ‘c’. Also, assume that the confidence level for deciding the cluster is ‘α’. The steps for G-means (X, α) may be depicted in Table 2.

TABLE 2
1: Let C be the initial set of centers (usually C ← {x̅})
2: C ← kmeans (C, X)
3: Let {xi | class(xi) = j} be the set of data points assigned to
center cj.
4: Use a statistical test [3] to detect if each {xi | class (xi) = j} follow a
Gaussian distribution (at confidence level α).
5: If the data look Gaussian, keep cj. Otherwise replace cj with
two centers.
6: Repeat from step 2 until no more centers are added.

At 308, the identical virtual machines in each of the clusters may be consolidated. In one example, there can be one of two possibilities to consolidate the identical virtual machines such as when all the host computing systems in the data center are empty (e.g., during hardware upgrade) and when the host computing systems are already executing corresponding virtual machines.

In one example, the host computing systems in the data center may be empty at the time of data center modernization (e.g., hardware upgrade), where existing host computing systems are being replaced by new ones. In this example, the clusters of identical virtual machines may be sequentially placed on the host computing systems. For example, the identical virtual machines in each of k clusters may be consolidated as follows:
Step 1: Starting with a biggest cluster (e.g., a cluster with maximum virtual machines), place as many virtual machines on a first host computing system based on resources availability of the first host computing system.
Step 2: When the first host computing system is filled, a second host computing system may be considered to place the virtual machines from the same cluster. Thus, all the identical virtual machines in the biggest cluster may be placed on one or more host computing systems (e.g., ‘m’ number of host computing systems) Hence, now these ‘m’ host computing systems can have maximum page sharing because the identical virtual machines are placed on these ‘m’ host computing systems.
Step 3: Steps 1 and 2 may be repeated until all the clusters are handled.
Step 4: In case of clusters with lesser number of identical virtual machines, the identical virtual machines in a cluster may be placed on a host computing system and some memory space may be kept empty on the host computing system or the identical virtual machines from two clusters may be placed on the host computing system. In both cases, memory optimization may be achieved.

In another example, when the host computing systems in the data center may be executing corresponding virtual machines, a virtual machine migration plan may be generated for the identical virtual machines in the clusters based on resources availability associated with the host computing systems. For example, the administrator may instruct to execute the virtual machine migration plan to migrate the identical virtual machines in each cluster. Further, the administrator may place possible number of identical virtual machines in a cluster on a same host computing system. Thus, examples described herein may generate the virtual machine migration plan and execute the virtual machine migration plan to significantly maximize memory page sharing.

FIG. 4 is a graphical representation 400 of identical virtual machines that are identified using a cluster analysis. For example, multiple virtual machines in the data center (e.g., virtual machines running in a lab infrastructure) that are distributed across different host computing systems may be considered. In one example, a cluster analysis (e.g., using G-means clustering algorithm) may be performed on configuration data and resource utilization data associated with the virtual machines to generate clusters of identical virtual machines. Example clusters (e.g., clusters formed based on parameter 1 and parameter 2 of the configuration data and the resource utilization data) including the identical virtual machines may be visually represented in FIG. 4.

In graphical representation 400, each eclipse (e.g., 402, 404, 406, 408, 410, and 412) represents a cluster including one type of virtual machines, where the identical virtual machines are represented by same symbol. In the example, there are 6 eclipses (e.g., 402, 404, 406, 408, 410, and 412) and hence there can be 6 different types of virtual machines in the lab infrastructure as depicted in Table 3.

TABLE 3

| VM Type | |
|---|---|
| Label | VMs used for applications |
| VM Type 1 | VMs running vROPs instances |
| VM Type 2 | VMs running Windows operating system for |
| | general purpose usage |
| VM Type 3 | VMs running vRealize Business for cloud application |
| VM Type 4 | VMs running remote data collectors |
| VM Type 5 | VMs running tomcat on Linux based OS |
| VM Type 6 | Ubuntu Machines used for general purpose by developers |

Further, in graphical representation 400, it can be observed that some of the data points are overlapping between two clusters indicating the virtual machines have common properties from two clusters. In this example, such virtual machines can be placed on any host computing systems which executes either of the two clusters. Thus, page sharing may be optimized and can achieve significant reduction in memory consumption.

Examples described herein may use machine learning to optimize memory page sharing of virtual machines, which may help private cloud administrators to optimize resources and reduce the cost of running the virtual machines. Examples described herein may be implemented in software solutions related to automatic delivery of new applications and updates like VMware® vRealize Operation as an optimization recommendation flow, where examples described herein may recommend an optimal plan for virtual machine movement across host computing systems in order to maximize memory page sharing. Also, examples described herein may be implemented in software solutions to automate optimization of complete infrastructure, e.g., VMware® vRealize Automation (vRA), where vMotion may be used to migrate virtual machines across the host computing systems without impacting any application.

### Example Processes

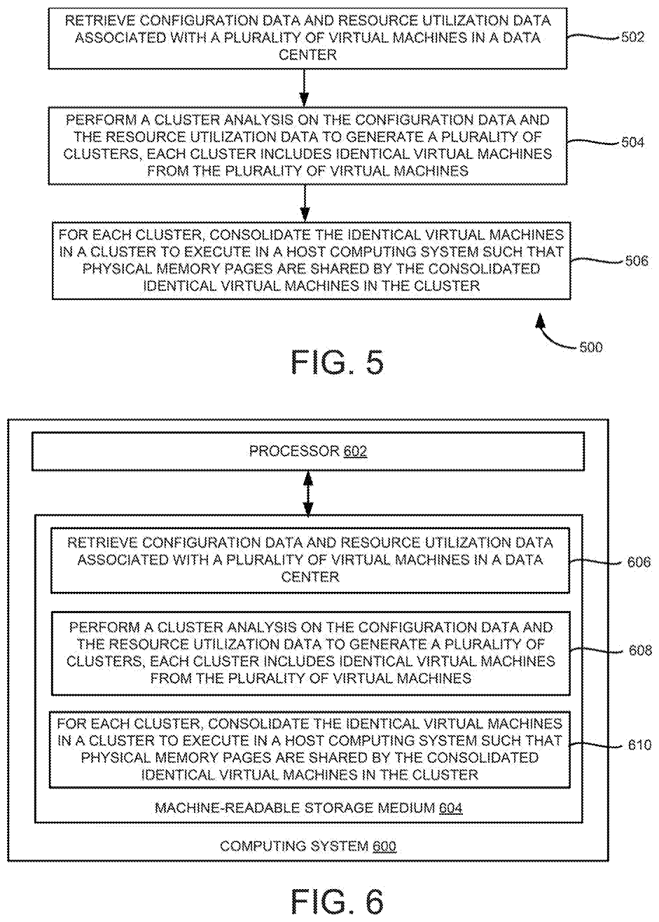

FIG. 5 is an example flow diagram 500 illustrating consolidation of identical virtual machines on host computing systems to enable page sharing. It should be understood that the process depicted in FIG. 5 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flow charts illustrate functional information to design/fabricate circuits, generate machine-readable instructions, or use a combination of hardware and machine-readable instructions to perform the illustrated processes.

At 502, configuration data and resource utilization data associated with a plurality of virtual machines in a data center may be retrieved. For example, the configuration data comprises at least one parameter selected from a group consisting of virtual machine inventory information, a guest operating system type and version, memory information, central processing unit (CPU) information, disk drive information, network adapter information, a type and version of an application, host computing system information, host cluster information, and/or configuration settings associated with each of the plurality of virtual machines. The resource utilization data comprises performance metric parameters selected from a group consisting of processor utilization data, memory utilization data, network utilization data, and/or storage utilization data.

At 504, a cluster analysis may be performed on the configuration data and the resource utilization data to generate a plurality of clusters, each cluster comprising identical virtual machines from the plurality of virtual machines. In one example, performing the cluster analysis on the configuration data and the resource utilization data may include encoding categorial variables associated with the configuration data and the resource utilization data and performing the cluster analysis on the encoded categorial variables to generate the plurality of clusters. For example, each cluster may include identical virtual machines with similar configurations based on at least one parameter selected from the configuration data and the resource utilization data. Further, the cluster analysis may include one of a G-means cluster, a support vector cluster, and the like.

At 506, for each cluster, the identical virtual machines in a cluster may be consolidated to execute in a host computing system such that physical memory pages are shared by the consolidated identical virtual machines in the cluster. In one example, the physical memory pages including identical content may be shared by the identical virtual machines using a page sharing mechanism.

In one example, consolidating the identical virtual machines in each cluster may include generating a virtual machine migration plan for the identical virtual machines in the plurality of clusters based on resources availability associated with a plurality of host computing systems in the data center. For example, the resources availability may include a processing resource availability, a memory resource availability, a network resource availability, a storage resource availability, or any combination thereof. Further, the virtual machine migration plan may be recommended to consolidate the identical virtual machines in each cluster to execute in a corresponding one of the host computing systems. Furthermore, the identical virtual machines may be migrated to consolidate the identical virtual machines in each cluster to execute in the corresponding one of the host computing systems in accordance with the recommended virtual machine migration plan.

In another example, consolidating the identical virtual machines in each cluster may include sequentially place the clusters of identical virtual machines on a plurality of host computing systems during hardware upgrade in the data center. For example, sequentially placing the clusters of identical virtual machines on the plurality of host computing systems during the hardware upgrade may include placing the identical virtual machines in a first cluster of the plurality of clusters on a first host computing system during the hardware upgrade in the data center such that the physical memory pages are shared by the placed identical virtual machines within the first host computing system. Further, the step of placing the identical virtual machines in a next cluster may be repeated until the identical virtual machines in all the clusters are placed on corresponding host computing systems in the data center.

FIG. 6 is a block diagram of an example computing device 600 including non-transitory machine-readable storage medium 604 storing instructions to consolidate identical virtual machines on host computing systems to enable page sharing. Computing system 600 may include a processor 602 and machine-readable storage medium 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random-access memory (RAM) or another type of dynamic storage device that may store information and machine-readable instructions that may be executed by processor 602. For example, machine-readable storage medium 604 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to computing system 600.

Machine-readable storage medium 604 may store instructions 606-610. In an example, instructions 606-610 may be executed by processor 602 for consolidate identical virtual machines on host computing systems to enable page sharing. Instructions 606 may be executed by processor 602 to retrieve configuration data and resource utilization data associated with a plurality of virtual machines in a data center. Instructions 608 may be executed by processor 602 to perform a cluster analysis on the configuration data and the resource utilization data to generate a plurality of clusters, each cluster comprising identical virtual machines from the plurality of virtual machines. Further, instructions 610 may be executed by processor 602 to consolidate, for each cluster, the identical virtual machines in a cluster to execute in a host computing system such that physical memory pages are shared by the consolidated identical virtual machines in the cluster.

Some or all of the system components and/or data structures may also be stored as contents (e.g., as executable or other machine-readable software instructions or structured data) on a non-transitory computer-readable medium (e.g., as a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method comprising:
retrieving configuration data and resource utilization data associated with a plurality of virtual machines in a data center;
performing a cluster analysis on the configuration data and the resource utilization data to generate a plurality of clusters, each cluster comprising identical virtual machines from the plurality of virtual machines; and
for each cluster,
consolidating the identical virtual machines in a cluster to execute in a host computing system such that physical memory pages are shared by the consolidated identical virtual machines in the cluster.

2. The method of claim 1, wherein performing the cluster analysis on the configuration data and the resource utilization data comprises:
encoding categorial variables associated with the configuration data and the resource utilization data; and
performing the cluster analysis on the encoded categorial variables to generate the plurality of clusters.

3. The method of claim 1, wherein consolidating the identical virtual machines in each cluster comprises:
generating a virtual machine migration plan for the identical virtual machines in the plurality of clusters based on resources availability associated with a plurality of host computing systems in the data center, wherein the resources availability comprises a processing resource availability, a memory resource availability, a network resource availability, a storage resource availability, or any combination thereof; and
recommending the virtual machine migration plan to consolidate the identical virtual machines in each cluster to execute in a corresponding one of the host computing systems.

4. The method of claim 3, further comprising:
migrating the identical virtual machines to consolidate the identical virtual machines in each cluster to execute in the corresponding one of the host computing systems in accordance with the recommended virtual machine migration plan.

5. The method of claim 1, wherein consolidating the identical virtual machines in each cluster comprises:
sequentially placing the clusters of identical virtual machines on a plurality of host computing systems during hardware upgrade in the data center.

6. The method of claim 5, wherein sequentially placing the clusters of identical virtual machines on the plurality of host computing systems during the hardware upgrade comprises:
placing the identical virtual machines in a first cluster of the plurality of clusters on a first host computing system during the hardware upgrade in the data center such that the physical memory pages are shared by the placed identical virtual machines within the first host computing system; and
repeating the step of placing the identical virtual machines in a next cluster until the identical virtual machines in all the clusters are placed on corresponding host computing systems in the data center.

7. The method of claim 1, wherein the physical memory pages including identical content are shared by the identical virtual machines using a page sharing mechanism.

8. The method of claim 1, wherein the cluster analysis comprises one of a Gaussian-means cluster and a support vector cluster.

9. The method of claim 1, wherein the configuration data comprises at least one parameter selected from a group consisting of virtual machine inventory information, a guest operating system type and version, memory information, central processing unit (CPU) information, disk drive information, network adapter information, a type and version of an application, host computing system information, host cluster information, and/or configuration settings associated with each of the plurality of virtual machines.

10. The method of claim 1, wherein the resource utilization data comprises performance metric parameters selected from a group consisting of processor utilization data, memory utilization data, network utilization data, and/or storage utilization data.

11. The method of claim 1, wherein each cluster comprising identical virtual machines with similar configurations based on at least one parameter selected from the configuration data and the resource utilization data.

12. A management node comprising:
a virtual machine classification unit to:
retrieve configuration data and resource utilization data associated with a plurality of virtual machines in a data center;
perform a cluster analysis on the configuration data and the resource utilization data to generate a plurality of clusters, each cluster comprising identical virtual machines from the plurality of virtual machines; and
a virtual machine migration unit communicatively coupled to the virtual machine classification unit to:
for each cluster,
consolidate the identical virtual machines in a cluster to execute in a host computing system such that physical memory pages are shared by the consolidated identical virtual machines in the cluster.

13. The management node of claim 12, wherein the virtual machine classification unit is to:
encode categorial variables associated with the configuration data and the resource utilization data; and
perform the cluster analysis on the encoded categorial variables to generate the plurality of clusters.

14. The management node of claim 12, wherein the virtual machine migration unit is to:
generate a virtual machine migration plan for the identical virtual machines in the plurality of clusters based on resources availability associated with a plurality of host computing systems in the data center, wherein the resources availability comprises a processing resource availability, a memory resource availability, a network resource availability, a storage resource availability, or any combination thereof; and
recommend the virtual machine migration plan to consolidate the identical virtual machines in each cluster to execute in a corresponding one of the host computing systems.

15. The management node of claim 14, wherein the virtual machine migration unit is to:
migrate the identical virtual machines to consolidate the identical virtual machines in each cluster to execute in the corresponding one of the host computing systems in accordance with the recommended virtual machine migration plan.

16. The management node of claim 12, wherein the virtual machine migration unit is to:
sequentially place the clusters of identical virtual machines on a plurality of host computing systems during hardware upgrade in the data center.

17. The management node of claim 16, wherein the virtual machine migration unit is to:
place the identical virtual machines in a first cluster of the plurality of clusters on a first host computing system during the hardware upgrade in the data center such that the physical memory pages are shared by the placed identical virtual machines within the first host computing system; and
repeat the step of placing the identical virtual machines in a next cluster until the identical virtual machines in all the clusters are placed on corresponding host computing systems in the data center.

18. A non-transitory machine-readable storage medium encoded with instructions that, when executed by a processor of a computing system, cause the processor to:
retrieve configuration data and resource utilization data associated with a plurality of virtual machines in a data center;
perform a cluster analysis on the configuration data and the resource utilization data to generate a plurality of clusters, each cluster comprising identical virtual machines from the plurality of virtual machines; and
for each cluster,
consolidate the identical virtual machines in a cluster to execute in a host computing system such that physical memory pages are shared by the consolidated identical virtual machines in the cluster.

19. The non-transitory machine-readable storage medium of claim 18, wherein instructions to consolidate the identical virtual machines in each cluster comprises instructions to:
generate a virtual machine migration plan for the identical virtual machines in the plurality of clusters based on resources availability associated with a plurality of host computing systems in the data center, wherein the resources availability comprises a processing resource availability, a memory resource availability, a network resource availability, a storage resource availability, or any combination thereof; and
recommend the virtual machine migration plan to consolidate the identical virtual machines in each cluster to execute in a corresponding one of the host computing systems.

20. The non-transitory machine-readable storage medium of claim 19, further comprising instructions to:
migrate the identical virtual machines to consolidate the identical virtual machines in each cluster to execute in the corresponding one of the host computing systems in accordance with the recommended virtual machine migration plan.

21. The non-transitory machine-readable storage medium of claim 18, wherein instructions to consolidate the identical virtual machines in each cluster comprises instructions to:
sequentially place the clusters of identical virtual machines on a plurality of host computing systems during hardware upgrade in the data center.

22. The non-transitory machine-readable storage medium of claim 21, wherein instructions to sequentially place the clusters of identical virtual machines on the plurality of host computing systems during the hardware upgrade comprises instructions to:
place the identical virtual machines in a first cluster of the plurality of clusters on a first host computing system during the hardware upgrade in the data center such that the physical memory pages are shared by the placed identical virtual machines within the first host computing system; and
repeat the step of placing the identical virtual machines in a next cluster until the identical virtual machines in all the clusters are placed on corresponding host computing systems in the data center.

23. The non-transitory machine-readable storage medium of claim 18, wherein the cluster analysis comprises one of a Gaussian-means cluster and a support vector cluster, and wherein each cluster comprising identical virtual machines with similar configurations based on at least one parameter selected from the configuration data and the resource utilization data.
